(19) United States
(12) Patent Application Publication
(10) Pub. No.: US 2025/0392468 A1
(43) Pub. Date: Dec. 25, 2025

(54) SYSTEM AND METHOD FOR PRIVACY-PRESERVING & POST-QUANTUM SECURE COUNTER-DENIAL OF SERVICE FOR SPECTRUM MANAGEMENT IN NEXT-GENERATION WIRELESS NETWORKS

(71) Applicant: UNIVERSITY OF SOUTH FLORIDA, Tampa, FL (US)

(72) Inventors: Attila Altay Yavuz, Tampa, FL (US); Saleh Darzi, Tampa, FL (US)

(21) Appl. No.: 19/239,448

(22) Filed: Jun. 16, 2025

Related U.S. Application Data
(60) Provisional application No. 63/662,555, filed on Jun. 21, 2024.

(51) Int. Cl. H04L 9/32

(52) U.S. Cl. CPC H04L 9/3236; H04L 9/3247

(57) ABSTRACT

An exemplary system and method for employing (i) a private spectrum bastion configured to verify every request to access a public server and respond to the requests with puzzles having spectrum access information to limit the impact of malicious traffic to a network spectrum, and (ii) privacy-preserving transmission and authentication protocols that obfuscate internet users' identifications when they request access from or communicate with a public server. The bastion provides computational puzzles embedded with spectrum access information to throttle malicious traffic at the network spectrum. The bastion operates with post-quantum cryptographic components and privacy-preserving protocols. The privacy-preserving protocols remain confidentiality of user identities and access patterns.

### RELATED APPLICATION

This application claims priority to, and the benefit of, U.S. Provisional Patent Application No. 63/662,555, filed Jun. 21, 2024, entitled “A System and Method for Privacy-preserving and Post-quantum Secure Counter Denial of Service for Spectrum Management in Next-Generation Wireless Networks,” which is incorporated by reference herein in its entirety.

### GOVERNMENT LICENSE RIGHTS

This invention was made with government support under CNS-2350213, awarded by the National Science Foundation. The government has certain rights in the invention.

### BACKGROUND

Spectrum access system (SAS) is a cloud-based, automated frequency coordination system that governs access to shared spectrum among multiple users. The SAS dynamically assigns spectrum to various user devices (e.g., radio service devices, mobile phones, etc.) based on real-time environmental sensing, geolocation data, and regulatory constraints. The SAS can ensure interference protection for incumbents and coordinate spectrum use among the users. SAS may also interface with environmental sensing capability (ESC) networks to detect incumbent activity and trigger spectrum reallocation.

There is a benefit to improving the spectrum access system.

### SUMMARY

An exemplary system and method are disclosed for employing (i) a private spectrum bastion configured to verify every request to access a public server and respond to the requests with puzzles having spectrum access information to limit the impact of malicious traffic to a network spectrum (e.g., provided by the Federal Communication Commission (FCC)), and (ii) privacy-preserving transmission and authentication protocols (e.g., private information retrieval (PIR) messages, quantum cryptography-compliant secure overlay networks) that obfuscate internet users' identifications when they request access from or communicate with a public server

Current SAS relies on static, centralized authentication methods that are vulnerable to denial-of-service attacks and expose sensitive user metadata during spectrum access requests. In contrast, the exemplary system and method utilize computational puzzles embedded with spectrum access information to throttle malicious traffic at the network spectrum, thereby reducing the burden on centralized infrastructure and enhancing system robustness. Furthermore, the integration of post-quantum cryptographic components (e.g., PQ-secure anonymity networks, e.g., PQ-Tor, PQ-Blockchain) ensures that the exemplary system remains secure even in the presence of adversaries equipped with quantum computing capabilities. The privacy-preserving protocols (e.g., PIR messages, post-quantum lattice-based puzzles) embedded in the exemplary system also ensure that user identities and access patterns remain confidential in both civilian and military wireless communication environments.

By solving the DoS vulnerability and metadata exposure, while also aligning with emerging post-quantum security standards (e.g., NIST-PQC standards), the exemplary system can provide a superior, distributed, and scalable solution for spectrum access systems. The exemplary system and method can enhance the reliability, security, and privacy of wireless communications in dynamic and adversarial environments, making it well-suited for applications in next-generation networks, critical infrastructure, and secure government communications.

In an aspect, a system (e.g., private spectrum bastion spectrum access systems (PSB-SAS)) is disclosed comprising a processor; and a memory having instructions stored thereon, wherein execution of the instructions causes the processor to: generate a privacy-preserving spectrum database (e.g., indexed matrix) to provide spectrum availability information in a privacy-preserving request from a user device, the spectrum database including a plurality of blocks corresponding to an accessible spectrum and assignable to a computing device, wherein each of the plurality of blocks is indexed by one or more privacy-preserving spectrum management parameters (e.g., coordinates, frequency channel number); generate one or more puzzles (e.g., based on predefined criteria for puzzle generation, e.g., pre-defined difficulty and/or pre-defined security), wherein each of the one or more puzzles is (i) stored in a respective index defined and retrievable by one or more privacy-preserving spectrum management parameters (e.g., to hide or obfuscate user device's location, frequency channel information, etc.) and (ii) assigned a signature associated with the respective puzzle and a secret key; and in response to a received privacy-preserving request (e.g., via a Private Information Retrieval (PIR) protocol, e.g., information-theoretic PIR or computationally secure PIR) from the user device to access a public server having services or data of interest to the computing device, the request including a plurality of privacy-preserving spectrum management parameters, retrieve a puzzle referenced in an index of the database using the plurality of privacy-preserving spectrum management parameters; transmit, via a quantum cryptography compliant and secure server (e.g., a quantum cryptography compliant and secure TOR, e.g., compliant with NIST-PQC standards) connected to the system, the retrieved puzzle and associated signature to the user device in a privacy-preserving response, wherein the transmitted puzzle is used by the user device to perform a computation task to determine a token, and wherein the token and signature are transmitted to the public server in a request for access to the public server.

In some embodiments, each of the one or more puzzles is a quantum-safe puzzle based on a cryptographic hash function.

In some embodiments, the puzzle is pre-computed and pre-stored.

In some embodiments, wherein each of the associated signatures is a Dilithium signature.

In some embodiments, the privacy-preserving request is received from a computing device via a Private Information Retrieval (PIR) protocol, including information-theoretic PIR (IT-PIR) or computationally secure PIR (e.g., lattice-based PIR).

In some embodiments, the puzzle is generated via a puzzle generation function that has function inputs associated with a difficulty level and a security level, and the difficulty level and/or security level is specified for different types of devices (e.g., of different computing resources).

In some embodiments, the token is determined using an identification (ID) of the public server and a hash value derived from the received puzzle.

In some embodiments, execution of the instructions causes the processor to: subsequent to the user device receiving the privacy-preserving response, check for data defects in the retrieved puzzle and/or associated signature; and in response to defects being detected in the retrieved puzzle and/or associated signature, reconstruct the privacy-preserving response using an error-correction algorithm.

In another aspect, a public server, accessible to a user device, is disclosed comprising a processor; and a memory having instructions stored thereon, wherein execution of the instructions causes the processor to: receive, from the user device seeking access to the server, an access request including a puzzle, a token, and a signature, wherein the received token was calculated from the puzzle retrieved by the user device from a privacy-preserving database, the user device retrieved the puzzle via an index determined from privacy-preserving spectrum management parameters that mask or obfuscate the user device identify or associated identify information; compute, via a signature verification operation, the validity of the received signature using a public key and the received signature; compute, via a token verification operation (e.g., hash operation), the validity of the received token using the retrieved puzzle and the received token; and in response to the signature of the received puzzle and the received token being valid, grant access to the user device (e.g., send a message indicating access).

In some embodiments, the puzzle is a quantum-safe puzzle (e.g., hash-based or lattice-based puzzle).

In some embodiments, the puzzle is pre-computed and pre-stored in a PSB.

In some embodiments, the signature is a Dilithium signature.

In some embodiments, the received puzzle is generated via a puzzle generation function that has function inputs associated with a difficulty level and a security level, and wherein the difficulty level and/or security level is specified for different types of devices (e.g., of different computing resources).

In yet another aspect, a non-transitory computer-readable medium for a user device is disclosed comprising instructions to (i) send a privacy-preserving request to a privacy-preserving spectrum database (e.g., indexed matrix) of a private spectrum bastion (PSB) to access a public server having services or data of interest to the user device, the user device having one or more privacy- preserving spectrum management parameters, and (ii) receive a puzzle referenced in an index of the database using the one or more privacy-preserving spectrum management parameters; instructions to determine a token using an identification (ID) of a public server accessible to the user device and a hash value derived from the received puzzle; instructions to transmit, via a quantum cryptography compliant and secure server (e.g., a quantum cryptography compliant and secure TOR, e.g., compliant with NIST-PQC standards) connected to the PSB, the received puzzle and associated signature, to the public server in a request for access to the public server.

In some embodiments, the non-transitory computer-readable medium described herein further comprises: subsequent to receiving the puzzle in a privacy-preserving response from the PSB, instructions to check for data defects in the received puzzle and/or the associated signature; and in response to defects being detected in the received puzzle and/or the associated signature, instructions to reconstruct the privacy-preserving response using an error-correction algorithm.

In some embodiments, the received puzzle is a quantum-safe puzzle (e.g., hash-based or lattice-based puzzle).

In some embodiments, the received puzzle is pre-computed and pre-stored.

In some embodiments, the associated signature is a Dilithium signature.

In some embodiments, the privacy-preserving request is received at the PSB from the user device via a Private Information Retrieval (PIR) protocol, including information-theoretic PIR (IT-PIR) or computationally secure PIR (e.g., lattice-based PIR).

In some embodiments, the received puzzle is generated via a puzzle generation function that has function inputs associated with a difficulty level and a security level, and wherein the difficulty level and/or security level is specified for different types of devices (e.g., of different computing resources).

### BRIEF DESCRIPTION OF DRAWINGS

FIGS. 1A-1C each shows an example privacy-preserving and counter-Denial-of-Service (counter-DoS) system for preserving the privacy of an internet user (e.g., location, identity, etc.) and countering DoS attacks when the user tries to access, via his/her user device, a public server by employing a private spectrum bastion (PSB) configured to provide, via an overlay network, the user device with puzzle and signature to solve for a token that the public server can verify to grant access to the user, in accordance with an illustrative embodiment. In FIG. 1B, the user device further employs a puzzle and signature checker configured to check the validity of the puzzle and associated signature provided by the PSB. In FIG. 1C, in addition to the user device employing the puzzle and signature checker, the communications between the PSB, the user device, and the public server happen via the overlay network.

FIGS. 2A-2B each shows an example operation flow for the exemplary system and method. Each flow shows the communication between three components of the exemplary system, including a user device, a private spectrum bastion (PSB), and a public server.

FIG. 3A shows an exemplary system having a private spectrum bastion (PSB), a client/user device, and a server. FIGS. 3B-3E show example algorithmic implementations for each of the components in FIG. 3A.

FIG. 4 shows the experimental analysis of the system in FIG. 3A for numerous client/user devices with various privacy configurations.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### EXAMPLE SYSTEM

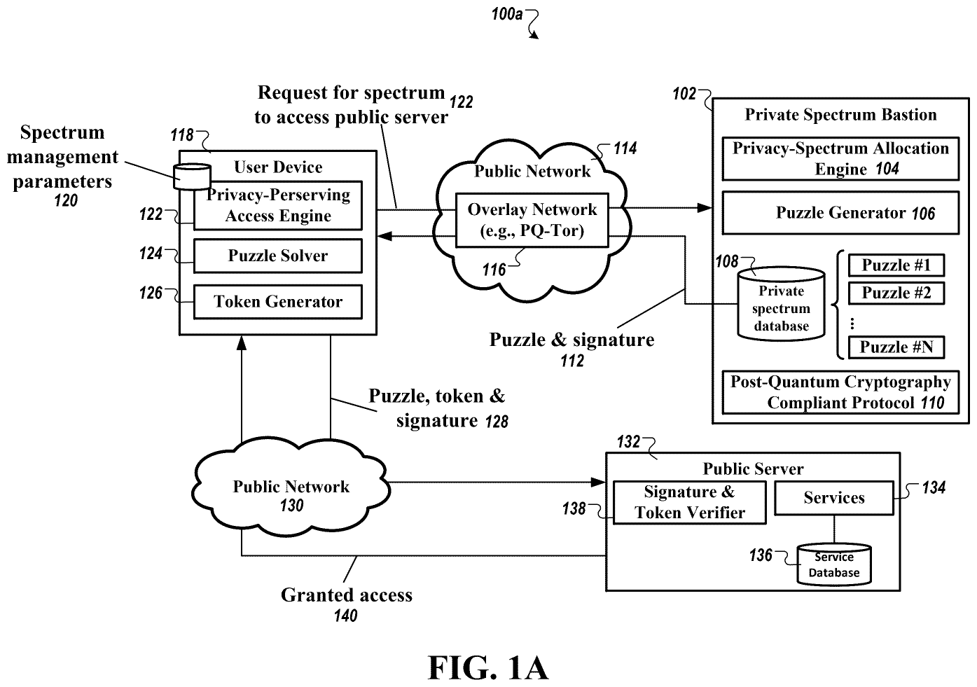

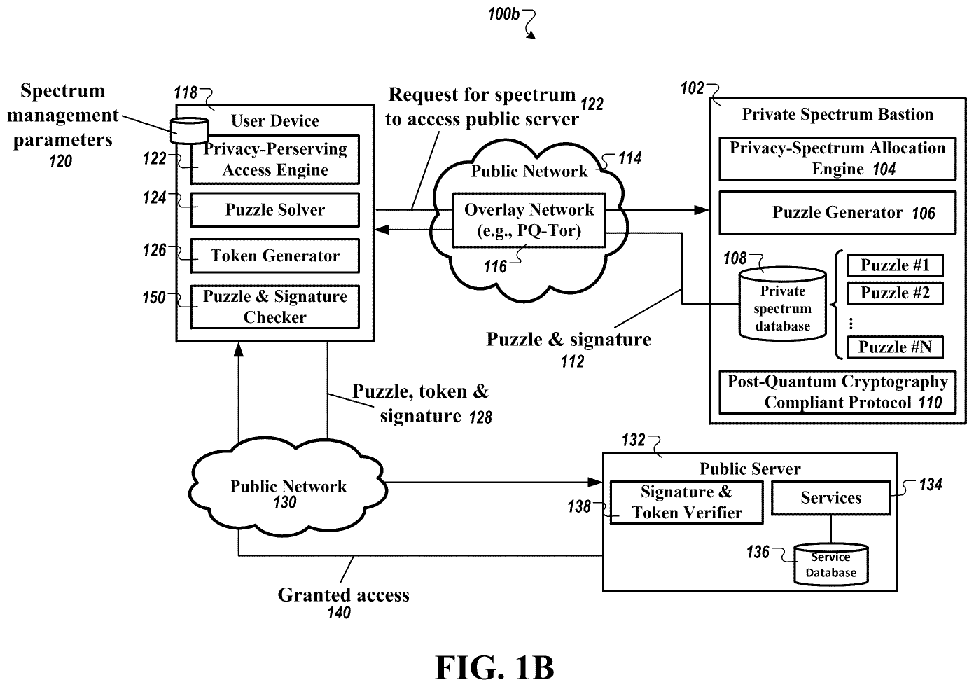

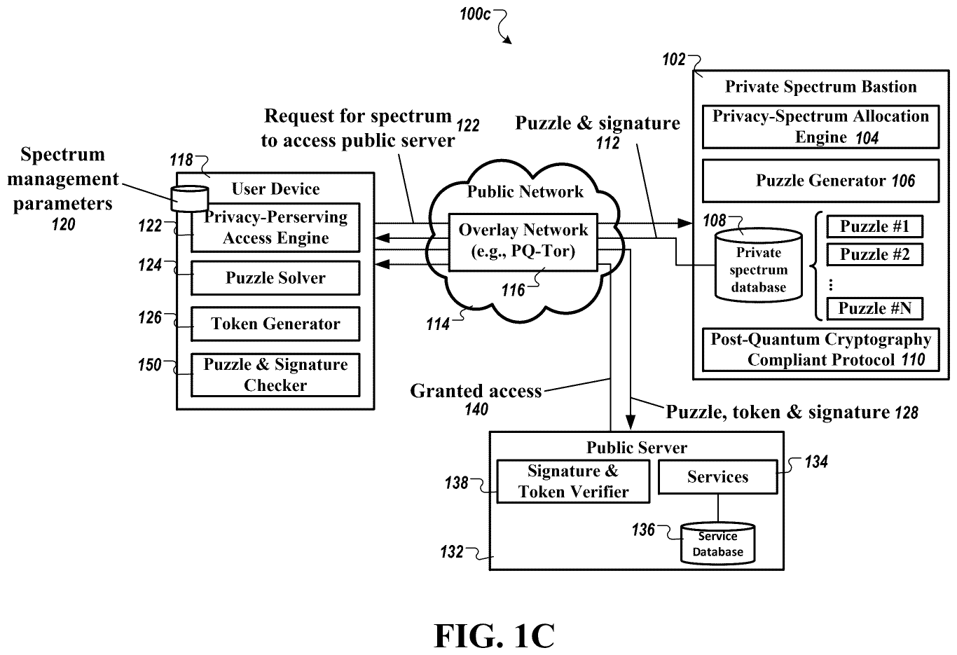

FIGS. 1A-1C each shows an example privacy-preserving and counter-DoS system for preserving the privacy of an internet user (e.g., location, identity, etc.) and countering DoS attacks when the user tries to access, via his/her user device 118, a public server by employing a private spectrum bastion 102 (PSB) configured to provide, via an overlay network 116, the user device with puzzle and signature (shown as 112) to solve for a token that the public server 134 can verify to grant access to the user, in accordance with an illustrative embodiment. In FIG. 1B, the user device 118 further employs a puzzle and signature checker 150 configured to check the validity of the puzzle and associated signature provided by the PSB 102. In FIG. 1C, in addition to the user device employing the puzzle and signature checker 150, the communications between the PSB 102, the user device 118, and the public server 132 happen via the overlay network 116.

Privacy-Preserving Private Spectrum Bastion (102). In the examples shown in FIGS. 1A-1C, before receiving, from the user device 118, a privacy-preserving request 122 for spectrum to access the public server 132, the PSB 102, via its privacy-spectrum allocation engine 104, can generate/set up a privacy-preserving spectrum database 108 (PSD) (e.g., indexed matrix) to allocate and provide users with spectrum availability information, in form of puzzles. The PSD 108 can hold a plurality of information blocks (e.g., puzzle #1, #2, . . . , #N), in respective indices, corresponding to a spectrum accessible and assignable to the user device. Each of the plurality of information blocks can be indexed by one or more privacy-preserving spectrum managements 120 (e.g., user device's location coordinates, frequency channel number, etc.) stored in the local memory of the user device 118 and included in the privacy-preserving request 122.

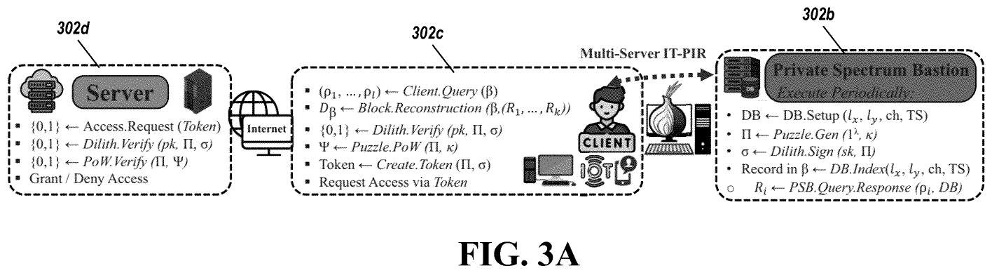

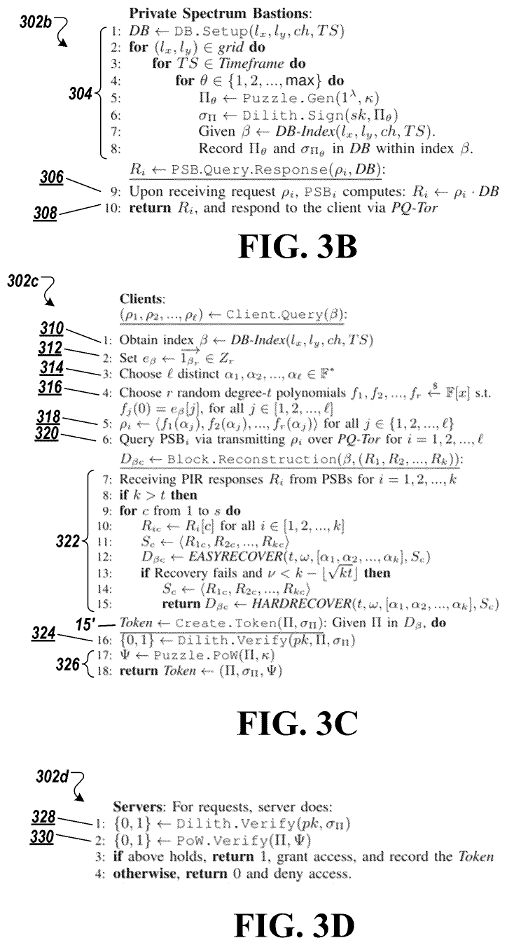

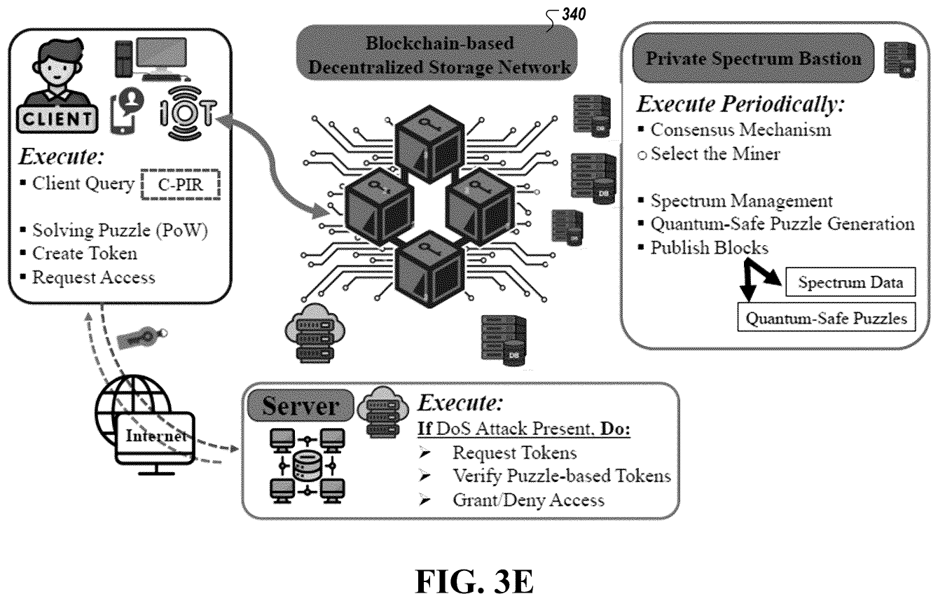

In one embodiment, the PSB 102, using its puzzle generator 106 (see lines 1-8, FIG. 3B), may generate one or more puzzles, based on predefined criteria for puzzle generation (e.g., predefined difficulty or security levels), in advance of receiving the privacy-preserving request 122; that is, the puzzles are pre-computed and stored in the PSD 108 prior to receipt of the request 122. In another embodiment, the PSB 102 may generate one or more puzzles in response to receiving the request 122; that is, the puzzles are computed and stored in the PSD 108 at the time the request 122 is received. The PSB can store each of the puzzles in a respective index, where each respective index can be (i) defined and retrieved by one or more privacy-preserving spectrum management parameters 120 (e.g., to hide or obfuscate user device's location frequency channel information, etc.) and (ii) assigned a signature associated with the respective puzzle and a secret key (e.g., of the user device 118). A signature associated with a respective puzzle can be a Dilithium signature or any one of the NIST-approved post-quantum signatures, including ML-DSA, SLH-DSA, and FN-DSA. The puzzles generated and stored in the PSD 108 can be either hash-based puzzles or post-quantum lattice-based puzzles (i.e., quantum-safe puzzles).

After receiving the request 122, the PSB 102 can retrieve a puzzle referenced in an index of the PSD 108 using the privacy-preserving spectrum management parameters 120 included in the request 122 (see line 9, FIG. 3B). Then, the PSB 102 can transmit, via an overlay network 116 built on top of a public network 114 that connects the user device 118 to the PSB 102, the puzzle and associated signature (shown as 112) to the user device 118 in a privacy-preserving response (see line 10, FIG. 3B). The user device 118 can then use the transmitted puzzle to determine a token that can be sent to the public server, along with the signature, to gain access to the public server 132.

In one embodiment, the overlay network 116 (also referred to as an anonymity layer) can be implemented as a quantum cryptography-compliant and secure network, e.g., a quantum cryptography-compliant and secure Tor compliant with NIST-PQC standards, so the PSB 102 may employ a post-quantum cryptography-compliant protocol module 110 to interact with the overlay network 116. In another embodiment, the overlay network 116 can be instantiated as a post-quantum variant of the Tor network or implemented over a post-quantum-secure blockchain.

Privacy-Preserving DOS-Countering User Device (118). In the examples shown in FIGS. 1A- 1C, the user device 118 (e.g., smartphone, tablet, smartwatch, etc.) can store spectrum management parameters 120 (e.g., location coordinates, frequency channel number, etc.) in its local memory. To request spectrum to access the public server having services or data of interest, the user device 118 can (i) generate, using its privacy-preserving access engine, the privacy-preserving request 122 (see lines 1-5, FIG. 3C) and (ii) transmit, via the overlay network 116, the request 122 to the PSB 102 (see line 6, FIG. 3C). The request 122 can include the spectrum management parameters 120 that the PSB can use to retrieve a puzzle referenced in an index of the PSD 108. The transmission of the request 122 can be via a private information retrieval (PIR) protocol, including information-theoretic PIR (IT-PIR) or computationally secure PIR (e.g., lattice-based PIR).

After receiving, via the overlay network 116, the puzzle and associated signature (shown as 112) in a privacy-preserving response from the PSD 108 of the PSD 102 (see line 7, FIG. 3C), the user device 118 can (i) derive, via its puzzle solver algorithm/operation 124 (see line 17, FIG. 3C), a hash value from the received puzzle and (ii) determine, via its token generator operation 126 (see line 15′, FIG. 3C), a token (e.g., access token) using a public identification (ID) of the public server 132 and the derived hash value. In some embodiments, the user device 118 can, via its puzzle and signature checker operation 150 (see lines 9-11 and 13-14, FIG. 3C), check for data defects in the received puzzle and/or associated signature before generating the token. If the user device 118 detects data defects, then it can reconstruct the privacy-preserving response using an error-correction algorithm (see lines 12 and 15, FIG. 3C). The user device 118 can then transmit, via a public network 130, the puzzle, token, and signature (shown as 128) to the public server 132 to gain access to the services or data of interest provided by the public server 132 (see line 18, FIG. 3C).

In FIG. 1C, the user device 118 can transmit the puzzle, token, and signature (shown as 128) to the public server via the same overlay network 116 that can be implemented as a quantum cryptography-compliant and secure network (e.g., PQ-secure anonymity network (e.g., PQ-Tor, PQ-blockchain) compliant with NIST-PQC standards).

DOS-Countering Public Server (132). In the examples shown in FIGS. 1A-1C, the public server 132 can receive, from the user device 118 seeking access to the services and data of interest 134 stored in the service database 136 of the public server 132, an access request having the puzzle, token, and signature (shown as 128). The puzzle and signature were (i) generated by the PSB 102, (ii) stored in the PSD 108, and (iii) transmitted to the user device 138 (e.g., in a privacy-preserving response) from an index of the PSD 108. The token was calculated by the user device 118 using (i) a hash value derived from the puzzle, and (ii) the public ID of the public server 132. After the receipt of the puzzle, token, and signature from the user device 118, the public server 132 can (i) determine, via a signature and token verifier 138, the validity of the signature and the puzzle associated with the signature (see line 1, FIG. 3D), and (ii) determine, via the signature and token verifier 138, the validity of the token using the token and the puzzle (see line 2, FIG. 3D). If the signature and the token are valid, the public server 132 can grant user device 138 (e.g., by sending a message indicating success) access 140 to the services 134 (see line 3, FIG. 3D). If the signature and the token are not valid, the public server 132 can deny the user device 138 access 140 to the services 134 (see line 4, FIG. 3D).

In some embodiments, the signature and token verifier can perform (i) a signature verification operation to determine he validity of the signature and the puzzle associated with the signature, (ii) a token verification operation to determine the validity of the token using the token and the puzzle, or (iii) a combination thereof.

### Example Operation Flow

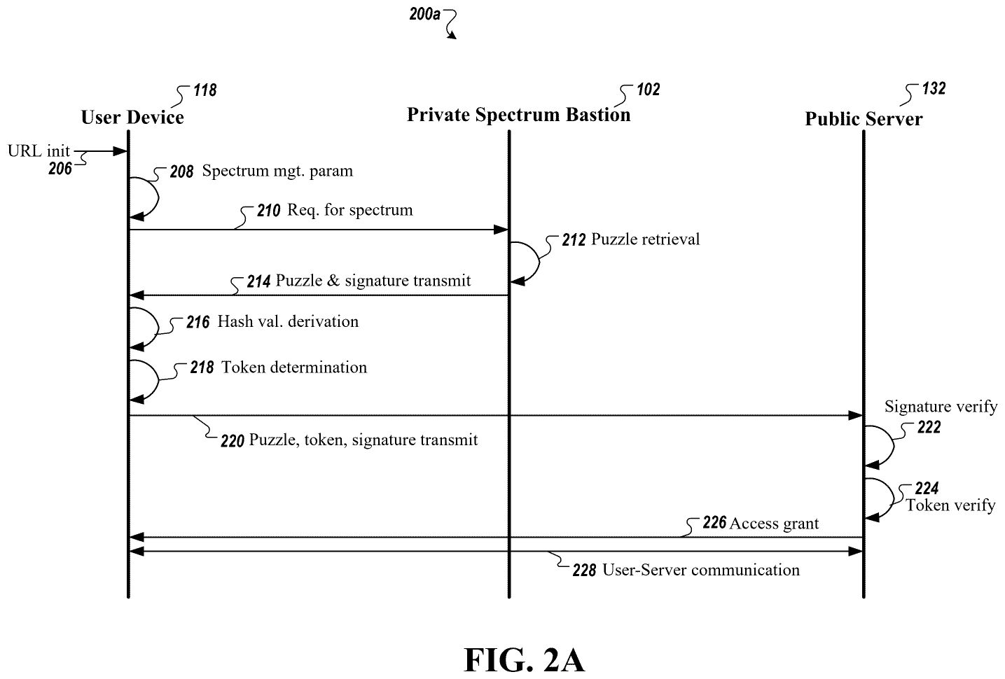

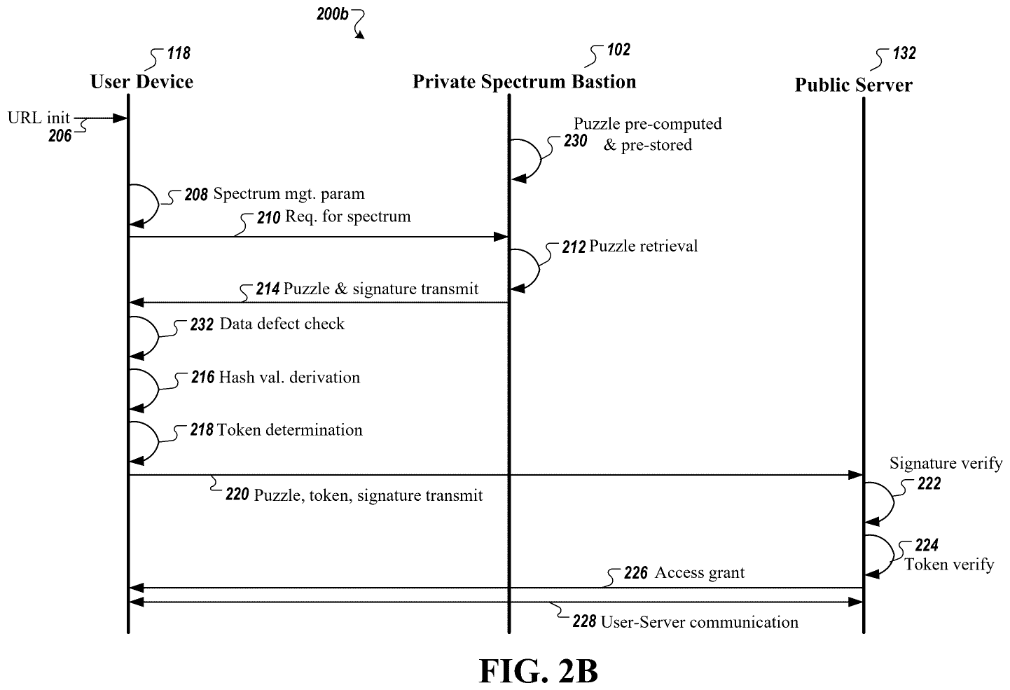

FIGS. 2A-2B each shows an example operation flow 200 (shown as 200a, 200b) for the exemplary system and method. Each flow 200a, 200b shows the communication between three components of the exemplary system, including a user device 118, a private spectrum bastion 102 (PSB), and a public server 132.

In the example shown in FIG. 2A, the flow 200a starts when an URL is initiated/entered (206) on a web browser of the user device 118. The user device 118, e.g., via the web browser or network utility application, then identifies (208) a set of spectrum management parameters (e.g., location coordinates, channel frequency number, etc.) and store the parameters in its local memory. The user device then transmits (210), to the PSB 102, a privacy-preserving request (see 122, FIGS. 1A-1C) for spectrum to access the public server 132. The privacy-preserving request includes the spectrum management parameters of the user device 118.

After receiving the privacy-preserving request from the user device 118, the PSB 102 retrieves (212) a puzzle referenced in an index of the private spectrum database (PSD) (see 108, FIGS. 1A-1C) using the spectrum management parameters included in the privacy-preserving request. The PSB 102 then transmits (214), via an overlay network (e.g., PQ-secure anonymity networks, e.g., PQ-Tor, PQ-Blockchain) (see 116, FIGS. 1A-1C), the puzzle and an associated signature (see 112, FIGS. 1A-1C) back to the user device 118 in a privacy-preserving response.

After receiving the puzzle and associated signature from the PSB 102 (in the privacy-preserving response), the user device calculates (216) a hash value from the puzzle, and determine (218) a token using a public identification (ID) of the public server 132 and the hash value derived from the puzzle. The user device 118 can then transmit (220) the puzzle, token, and signature (see 128, FIGS. 1A-1C) to the public server 132 to seek access to the services and data of the public server 132.

After receiving the puzzle, token, and signature from the user device 118, the public server 132 determines (222), via a signature verification operation (see 138, FIGS. 1A-1C), the validity of the received signature and puzzle, and determine (224), via a token verification operation (see 138, FIGS. 1A-1C), the validity of the received token using the received puzzle and token. If the received signature, puzzle, and token are valid, the public server 132 can grant (226) the user device 118 access to the services and data of the server 132. The user device 118 and the public server 132 then communicate (228) (e.g., send/receive resources) back and forth with each other.

In the example shown in FIG. 2B, before the identification (208) of the spectrum management parameters at the user device 118, the PSB 102 pre-computes and pre-stores (230) puzzles in the indices of its PSD. Before the calculation (216) of the hash value from the puzzle received from the PSB 102, the user device 118 checks (232) for defects in the puzzle and signature included in the privacy-preserving response received from the PSB 102. If the user device 118 detects data defects, the user device 118 reconstructs, via an error-correction algorithm, the privacy-preserving response to resolve the data defects.

### Example System for Privacy-Preserving Counter-Denial of Service

In some implementations, the exemplary system (also referred to as Privacy and Anonymity preserving Counter-DoS in the post-Quantum era (“PACDoSQ”) system) can comprise three components: (i) private spectrum bastions (PSBs) comprising multiple geo-location spectrum databases [1], [15] that provide spectrum availability information and maintain synchronicity and consistency of the information under Federal Communications Commission (FCC) guidelines, (ii) client device (also referred to as user device), including mobile device (e.g., laptops), configured to connect to the servers for network services by obtaining spectrum availability from PSBs, and (iii) servers, including network servicing platforms (e.g., web/cloud servers), configured to connect and provide services to the client device.

Initial Setup at PSBs. Table 1 shows descriptions of the initial setup for components (e.g., PSB and PQ-secure anonymity networks, e.g., post-Quantum Onion router (PQ-Tor), PQ-Blockchain) of the exemplary system.

TABLE 1

| Component | Description |
|---|---|
| Database (DB) | The PSBs can synchronize their DB by incorporating various |
| of the PSBs | parameters, e.g., location coordinates (lₓ, l_{y}), frequency channel |
| | number (ch), and spectrum data. DB can be conceptualized (and |
| | simplified) as a matrix with dimensions r × s, where each row (r) |
| | represents one data block comprising b bits. Each block can consist of |
| | s words, each with a size of w bits formatted as GF(2^{w}) (as in [2], [5]). |
| | PSBs can maintain other relevant information stipulated by the FCC |
| | (as in [15]), e.g., row index of coordinates with proper subroutines, for |
| | brevity herein referred to as DB-Index(.). |
| PQ-Tor | The PQ-Tor is a state-of-the-art Tor: (i) where Rivest-Shamir- |
| | Adleman (RSA) signature is replaced with Dilithium signing in the |
| | consensus part, (ii) the RSA key encapsulation mechanism (KEM) is |
| | substituted with Kyber KEM in circuit creation, and (iii) advanced |
| | encryption standard 128 bits (AES-128) is replaced with AES-256 to |
| | double the symmetric key size against Grover's algorithm [21]. |

FIG. 3A shows an exemplary system (“PACDoSQ”) having a private spectrum bastion (PSB), a client/user device, and a server. FIGS. 3B-3D show example algorithmic implementations (e.g., 302b-302d) for each of the components (e.g., PSB, client/user device, and server) in FIG. 3A.

Puzzle Management and Private Spectrum Service at PSBs. FIG. 3B shows an example algorithmic implementation 302b for the private spectrum bastion (see 102, FIGS. 1A-1C).

At lines 1-8 (304), PSBs set up a database (DB) by generating spectrum management context (e.g., coordinates, channels), puzzles, and their PQ signatures. Within defined segments of the grid marked by specific coordinates for multiple time frames, they generate quantum-safe puzzles (e.g., hash-based or lattice-based puzzles) and sign them according to predetermined indices derived from ((lₓ, l_{y}), ch, TS). The puzzles and Dilithium signatures can be updated periodically according to the puzzle difficulty/validity interval (e.g., every hour). The quantity of puzzles generated can depend on factors such as the number of servers and their maximum capacity (max).

At line 9 (306), PSBs can handle the spectrum query first via the fault-tolerant multi-server private-information-retrieval (PIR) (or any post-quantum secure PIR, e.g., IT-PIR, lattice-based PIR) that permits an information-theoretically private retrieval of coordinate availability, puzzle, and their signatures. At line 10 (308), the PIR response can be sent to the client via PQ-Tor (or other PQ-secure anonymity networks, e.g., PQ-Blockchain) to ensure anonymity.

Private Availability Information and Quantum-Safe Puzzle Retrieval at Client Device. To comply with FCC regulations and participate in the counter-DoS mechanism for accessing a networking services server, the client device can retrieve puzzles and spectrum information from the PSBs. FIG. 3C shows an example algorithmic implementation 302c for the client/user device (see 118, FIGS. 1A-1C).

At line 1 (310), the client device use the coordinates, frequency channel, and timestamp to determine the target index 8 within the PSB's DB. Subsequently, at line 2 (312), the client device constructs a PIR request by selecting a basis vector \vec{1_{βr}}, where all elements are zero except for index β, which can be set to one. Furthermore, considering [symbol] PSBs and utilizing Shamir's secret sharing technique, the client device can select random elements from F*(at line 3 (314)), generate r random polynomials with a degree of t satisfying ƒⱼ(0)=e_{β}[j] (at line 4 (316)), and create [symbol] PIR requests ρ(at line 5 (318)). Finally, at line 6 (320), the client device can dispatch the PIR requests to each PSB's DBᵢ via PQ-Tor (or other PQ-secure anonymity networks, e.g., PQ-Blockchain).

Lines 7-15 (322) involve the client's query recovery phase. Assuming that k out of [symbol] PSB servers respond to the client device, the client device can reconstruct the block using the EASYRECOVER subroutine as described in [16], which relies on the Lagrange interpolation technique. If a sync/transmission error occurs or an incorrect block is returned by v<k servers (e.g., a Byzantine (compromised) server), the client device can use the HARDRECOVER algorithm based on error-correction codes to handle the error. By reconstructing the block item with one of these recovery algorithms, the client device can retrieve the puzzle, whose validity can be confirmed by verifying PSB's signature (line 16 (324)).

Proof-of-Work (PoW) and Token Creation at Client Device. The online phase of the exemplary system begins when the client device performs the POW and generates the Token. At lines 17-18 (326), given the quantum-safe puzzle (II) and the target network service ID (ID_{S}), the client device can conduct a brute-force search through a nonce (N_{C}) to discover a hash value h(IDₛ, TS, N_{B}, N_{C}) with κ-bit leading zeroes. Then, upon identifying a solution, the client device can generate the token, which comprises the PSBs' and client device's nonces along with the TS and ID_{S}, and transmits the token to the server.

Access Requests at Server. FIG. 3D shows an example algorithmic implementation 302d for the server (see 132, FIGS. 1A-1C).

The client device can submit a request to the server with the token for a given time interval. The server can first verify the puzzle's validity by checking the PSB's signature (at line 1 (328)), followed by efficiently verifying the Token using a hash operation (at line 2 (330)). Only if the puzzle solution is valid and authentic does the server grant access to the client device.

FIG. 3E shows another exemplary system (“PACDoSQ”) in which the PSB and the client/user device communicate over a blockchain-based network 340, rather than a public network (see 114, FIGS. 1A-1C).

### EXAMPLE SECURITY NOTATIONS, CRYPTOGRAPHIC PRIMITIVES, AND ELEMENTS

The exemplary system employs various security notations, cryptographic primitives, and elements, as described herein.

Security Notations. |x| and {0, 1}^{k} signify the bit length of a variable and a k-bit binary value, respectively. F, GF(2), and Z denote a finite field, a Galois Field with modulo 2, and a set of integers, respectively.

$${\{ {x}_{i} \}}_{i = 1}^{ℓ}$$

and ←S denote (x₁,x₂, . . . x [symbol] ) and random selection from the set S, respectively. The function h(.) denotes a cryptographically secure hash function. sk and pk denote secret and public keys, respectively.

Private Information Retrieval (PIR). The PIR construction can facilitate a client to retrieve a block of information from a database without revealing the privacy of the retrieved item to the database server(s). The exemplary system can employ multi-server PIR since it employs one or more spectrum databases in the PSBs. The PIR can be the fault-tolerant IT-PIR [16] that provides v-byzantine robustness, ensuring the reconstruction of the target block even if v servers provide incorrect responses. The PIR can also be any post-quantum secure PIR, including information-theoretic PIR (IT-PIR) or computationally secure PIR (e.g., lattice-based PIR).

PQ-Secure Primitives. The exemplary can utilize National Institute of Standards and Technology Post-Quantum Cryptography (NIST PQC) standardized lattice-based schemes for KEM and signature, namely Kyber [18] and Dilithium [19], respectively. The Kyber KEM can be formed on the Module-LWE problem and comprises three algorithms (Kyber.KeyGen, Kyber.Encap, Kyber.Decap). The Dilithium signature can also be formed on Module-LWE and comprises three algorithms: (sk, pk) ←Dilith.KeyGen(1^{λ}); σ← Dilith.Sign(sk, m); and {0, 1}← Dilith.Verify(pk, m, σ).

Quantum-safe Puzzles. The PSB of the exemplary system can generate quantum-safe puzzles [20] that can comprise three functions (Gen, PoW, Verify). Table 2 shows descriptions of the three functions (Gen, PoW, Verify) for quantum-safe puzzles used in the exemplary system.

TABLE 2

| Function | Description |
|---|---|
| Π ← Puzzle.Gen(1^{λ}, κ) | Given the security parameter λ and the difficulty level κ, this function |
| | (employed by the PSBs) selects a random nonce N ← {0, 1}^{κ} and |
| | produces quantum-safe puzzles Π = (N, κ). |
| Ψ ← Puzzle.PoW(Π, κ) | Given a puzzle Π, this function (employed by the client device) brute |
| | forces a nonce Ψ = Nₓ to obtain a hash value with κ-bit leading zeros, |
| | 0₁0₂0₃ . . . 0_{κ}Y ← h(Π, Nₓ), where Y ∈ {0, 1}^{\|h\|-κ}. |
| {0, 1} ← PoW.Verify(Π, Ψ) | This function (employed by the server) checks if the first κ bits of the |
| | hash value of h(Π, Nₓ) are zero. |

### Experimental Results and Additional Examples

A study was conducted to develop and evaluate an exemplary system (also referred to as “PACDoSQ”) comprising at least a private spectrum bastion (PSB), a client/user device, and a public server, as described in relation to FIGS. 1-3. The PACDoSQ as a novel cybersecurity framework is designed to address the multifaceted challenges of security, privacy, and DoS attacks in SAS amidst the expanding mobile and IoT landscape and the looming threat of quantum computing. By integrating PSBs with multi-server PIR, PQ-secure Tor, and quantum-safe client-server puzzles PACDoSQ offers a comprehensive solution that ensures location privacy, anonymity, and resilience against DoS attacks in the PQ era. Formal security proofs validate the security of PACDoSQ, while comprehensive performance evaluations underscore its feasibility and efficiency. As network services continue to evolve, PACDoSQ stands as an important step towards establishing a holistic cybersecurity framework safeguarding spectrum management systems from a myriad of cyber threats with reasonable overhead

Security Analysis The system of the study can capture various attacks at the intersection of counter-DoS, privacy, anonymity, and basic security services, all under the threat of quantum computing. First, client devices may launch DoS attacks on the servers. To mitigate such attacks, the study considered the system (as counter-DoS threat model) in outsourced puzzle settings, where PSBs assumed the Bastion role for puzzle management. Second, client's location privacy and identity information may be under threat due to the FCC's requirement of sharing coordinates and device specs with spectrum management databases. In the system of the study, PSBs carried out this duty along with puzzle management. Hence, the study considered that PSBs can be curious about the location and identity information of the clients. Third, some (but a small set of) PSBs may be compromised and therefore may act as Byzantine servers (do not respond or provide incorrect input). Fourth, the attacker is quantum computing capable and can use it to launch attacks as well as to threaten basic security services such as confidentiality, authentication, and integrity (which may be achieved through services like TLS).

Table 3 shows the objectives and implementation detail of the system in the study.

TABLE 3

| Objective | Details |
|---|---|
| Client Privacy and Anonymity | Clients' location privacy (i.e., coordinates), device specs, and |
| | identity remain confidential and anonymous during spectrum |
| | availability and puzzle retrieval from the PSBs and external |
| | attackers. |
| Resilience to Partial Failure and | The client can retrieve and reconstruct the intended block item |
| Byzantine Behavior | (including spectrum and puzzle data) even if some subset of the |
| | PSBs can act non-responsive or maliciously. |
| DoS Mitigation | A measurable and provable countermeasure against DoS attacks |
| | is employed. |
| PQ-security | All the above objectives are achieved in the presence of quantum |
| | computing-capable adversaries. |

Table 4 shows security proofs and assumptions for the design of the system of the study.

TABLE 4

| Lemma/Corollary | Proof |
|---|---|
| Lemma 1: The system of the study can | By utilizing ( [symbol] , t)-Shamir secret sharing, with the assumption |
| ensure t-private k-out-of- [symbol] information- | of k honest responses from [symbol] PSBs where k > t, the target |
| theoretically secure location privacy and | index β, along with the client's private information, |
| computationally secure anonymity via | including location and transmission details, remains |
| onion routing. | confidential during the block retrieval process, even in the |
| | event of collusion among t PSBs with 0 ≤ t ≤ [symbol] − 1. The |
| | deployment of onion routing with a minimum of three |
| | intermediate nodes, each possessing knowledge solely of its |
| | predecessor and successor, alongside communication |
| | through a circuit with layers of symmetric encryption using |
| | AES-256 keys derived via a Module-LWE-based KEM |
| | scheme, ensured the anonymity and untraceability of the |
| | client device's identity and activities against both PSBs and |
| | eavesdropping adversaries. |
| Corollary 1: The system of the study can | The system of the study can provide block reconstruction |
| attain v-Byzantine-Robustness with v < | from client-device-received query responses (e.g., |
| k − └\sqrt{kt}┘. | communication failures, malicious drop) by employing the |
| | Guruswami-Sudan list decoding algorithm capable of |
| | correcting v < k − └\sqrt{kt}┘ errors and ( [symbol] , t)-Shamir secret |
| | sharing with k responding PSBs (k > [symbol] ). |
| Corollary 2: The system of the study can | The server only accepts puzzle solutions with PSB's |
| provide enhanced counter-DoS for the | signature, eliminating the possibility of puzzle forgery. |
| servers via client-server puzzles. | Since PoW requires O(2ⁿ) trials (for classical settings), the |
| | adversary needs an average of O(2^{κ}) hash operations to |
| | acquire a valid token for the server, where a puzzle is only |
| | valid for a designed amount of time, depending on the |
| | difficulty level κ. |
| Lemma 2: The system of the study can | (i) The location privacy guarantees and robustness features |
| achieve the objectives in Lemma 1 and | in Lemma 1 and Corollary 1, respectively, are information- |
| Corollary 1-2 with PQ-security. | theoretically secure, and therefore remain unaffected by the |
| | adversary's computational power, including quantum |
| | computers [16]. (ii) The onion routing anonymity in Lemma |
| | 1 relies on 128-bit PQ security of the AES-256 [22] given |
| | Grover's algorithm and the hardness of the Module-LWE |
| | problems, which can be reduced from the worst-case |
| | Module-SIVP problem in the random oracle model [18]. (iii) |
| | The end-to-end security and PQ-TLS security of PQ-Tor and |
| | authentication of puzzles also achieve the same level of PQ- |
| | security via the NIST PQC framework [4]. (iv) The |
| | quantum-safe puzzle in Corollary 2 can provide an O(2^{κ/2}) |
| | level of PQ security due to Grover's probabilistic algorithm, |
| | and by adjusting the time validity of the PoW accordingly, |
| | the quantum-safe puzzles provide robust PQ counter-DoS |
| | mitigation for the exemplary ssytem. |

Performance Evaluation. The system of the study was evaluated and the evaluation metrics and experimental results (e.g., computational costs, communication and storage overheads, scalability) were described herein.

Evaluation Metrics and Rationale. The computational, communication, and storage overheads of the system of the study were considered for multi-server PIR, puzzle generation, PoW, token verification, and overhead of PQC, including PQ-Tor components. The study also investigated scalability aspects, including end-to-end delay perceived by the client device for an increased number of users, networking conditions, and PSB configurations. The configuration of PSB servers specifies the privacy levels achieved during block retrieval; for instance, (3, 2) indicates that privacy is maintained if any 2 out of 3 PSBs collude. The system of the study was the first to provide location privacy, anonymity, and resiliency for puzzle-based counter DoS with PQ-security. Therefore, a vis-à-vis performance comparison with state-of-the-art counterparts was not feasible. Instead, the study focused on providing a detailed performance evaluation for given metrics to assess the potential feasibility of our framework.

Hardware, Software, Libraries, and Parameters. The study utilized a desktop computer configured with an 11th Gen Intel Core i9-11900 K processor at 3.50 GHz, 64.0 GB of RAM, a 1 TB SSD, and Ubuntu 22.04.4 LTS. The study utilized various Virtual Machines (VMs) running Ubuntu to simulate multiple PSB/PIR/PQ-ToR interactions. The study used the Percy++ library for the multi-server PIR, the Open Quantum-Safe library for PQC primitives, and OpenSSL for hash. The PSB used SQLite and Python databases. The study used AES-256, Kyber for the KEM part, and Dilithium for the signature part of PQ-Tor. The quantum-safe puzzles were formed on SHA-256. The study relied on NIST-PQC level I security for Kyber [18] and Dilithium [19].

Data and Format Selection. The database structure of the PSB was a matrix with varying row sizes (e.g., 2¹⁰, 2¹², 2¹⁴, 2¹⁷), where each row represented a single block of data. Utilizing publicly available raw data from the FCC, the study estimated that each block in the database may contain approximately 560 bytes of information, excluding puzzles and signatures. Within a designated grid segment defined by coordinates lₓ and l_{y}, the study populated databases with synthetic data representing spectrum information and signed quantum-safe puzzles stored in PSBs, synchronized as mandated by the FCC [1].

Computation Costs. Table 5 shows the computational costs of the system of the study.

TABLE 5

| Entity/Component | Operations | Parameter | | | | | | | |
|---|---|---|---|---|---|---|---|---|---|
| PSB | Puzzle generation & sign | \|DB\| | | | | | | | |
| | | 2¹⁰ | | 2¹² | | 2¹⁴ | | 2¹⁷ | |
| | | 31 | ms | 310 | ms | 3.1 | s | 31 | s |
| | Query response | 2.3 | ms | 5.4 | ms | 17.3 | ms | 109.9 | ms |
| Client device | Query & reconstruction | 0.9 | ms | 2.1 | ms | 5.7 | ms | 12.5 | ms |

| Puzzle signature verify | 30 μs | | | |
|---|---|---|---|---|
| PQ-Tor Computations | 255.6 μs | | | |
| Proof of Work (PoW) | κ: 14 | κ: 18 | κ: 20 | κ: 23 |

| | | | | | | | |
|---|---|---|---|---|---|---|---|
| 5.73 | ms | 91.7 | ms | 367 | ms | 2.93 | s |

| | | |
|---|---|---|
| Server | Puzzle signature verify | 30 μs |
| | Token verification | 0.35 μs |

Note:
one client device, one PSB, and a server in a (3,2) configuration setting, with a fixed block size of 2.93 KB and varying database entries (|DB|).

The study determined the computational cost analysis, which is presented in Table 5. The analysis is provided as follows. (i) The Dilithium signature with the puzzle entailed key generation, signing, and verification of 29 μs, 84 μs, and 30 μs, respectively. Puzzle generation and verification each required approximately one hash, while solving (PoW) demanded brute force corresponding to the difficulty levels denoted by κ. The difficulty level was κ/2 for quantum attacks with Grover's algorithm. (ii) With t_{⊕} representing the time for one XOR, analytical costs were (n/w)·t_{⊕} for PIR computations on the client side and [symbol] ·( [symbol] −1)·r·t_{⊕}+3 [symbol] ·( [symbol] +1)·t_{⊕} on the PSB side. The empirical costs, as shown in Table 3, show that the expenses for PIR increased linearly with the size of the database. (iii) PQ-Tor's costs were circuit build and applying encryption layers dominated by the three Kyber and AES operations. Kyber key generation, encapsulation, and decapsulation each took 10 μs, 13.4 μs, and 9 μs, respectively, while AES-256 only cost 7 μs for key generation and 8 μs for encryption.

Communication and Storage Overheads. Table 6 shows the communication and storage overheads of the system of the study.

TABLE 6

| | \|DB\| | | | | | | | |
|---|---|---|---|---|---|---|---|---|
| Operation | 2¹⁰ | | 2¹² | | 2¹⁴ | | 2¹⁷ | |
| Total Communication | 12.98 | KB | 25.99 | KB | 77.69 | KB | 605.92 | KB |
| Client's Storage | 4.19 | KB | 17.2 | KB | 68.9 | KB | 597.13 | KB |
| PSB's Storage | 4.1 | MB | 16.8 | MB | 67.3 | MB | 538.2 | MB |
| Communication Delay | ≈145 | ms | ≈175 | ms | ≈275 | ms | ≈650 | ms |

| | |
|---|---|
| Circuit RTT Latency | ≈250 ms |

Table 6 shows a summary of the communication and storage overhead analysis. The analysis is as follows. (i) Multiserver PIR was the predominant cost due to its communication overhead. The communication cost of retrieving \sqrt{nw} bits from [symbol] PSBs was approximately [symbol] ×\sqrt{nw}. The transmitted data volume increased linearly with the number of database entries. (ii) The storage overhead at the client side was minimal, but that of PSBs increased linearly with the number of puzzles and signatures. The quantum-safe puzzle II=(κ, N_{B}) featured a difficulty level κ of 4 bytes and a nonce N_{B} of κ bits, with a Dilithium signature size of 2.363 KB. Given these specifications, each block had a fixed size of 2.93 KB, resulting in database sizes of 4.1 MB, 16.8 MB, 67.3 MB, and 538.2 MB, respectively, for a grid segment. (iii) The communication aspect of PQ-Tor mirrored state-of-the-art Tor, with negligible differences (e.g., Kyber ops). Thus, the study utilized state-of-the-art Tor network metrics for communication delay estimation [23]. Despite Kyber being faster than state-of-the-art RSA used in Tor, employing Kyber necessitated two packet transmissions due to Tor's default packet size of 512 bytes, resulting in an average bound of 300 ms for circuit build time. The communication delay entailed the average timing of sending PIR requests and receiving PIR responses via PQ-Tor within a built circuit.

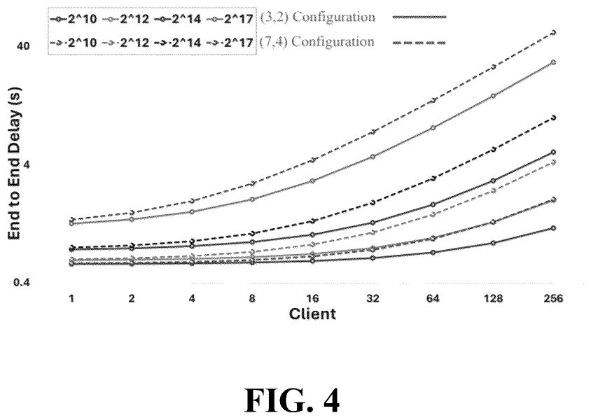

Scalability Assessment. The study evaluated the performance of the system of the study for an increasing number of client devices and various PSB configurations, offering different trade-offs between privacy and speed. The evaluation in the study combined computational and communication overheads to analyze the perceived end-to-end delay for the clients and PSB servers. The client device can retrieve its puzzle along with spectrum availability information offline. The process involved fetching the signed puzzle from PSBs using multiserver PIR over PQ-Tor. The end-to-end delay encompassed the PIR computation on both the client and PSB sides, as well as the communication delays due to PQ-Tor when fetching a block of data from multiple PSB databases. FIG. 4 shows the experimental analysis of the system of the study for numerous client/user devices with various privacy configurations. Upon retrieving the puzzle, the client can connect with the server by solving PoW and sending its solution with the token. This (online) phase was swift and mirrored state-of-the-art client-server puzzle settings, with the key difference being that the request was transmitted through a PQ-secure TLS channel.

### Discussion

With the progression of wireless network services (e.g., 5G/6G), coupled with the expansion of mobile and IoT applications, the significance and frequency of threats to such services, specifically spectrum access systems (SAS), are escalating [1]. Among these threats, the sophistication and execution of Denial of Service (DoS) attacks are becoming prevalent, due to the availability of open-source software, enhanced processing capabilities, and the proliferation of inexpensive devices. DoS attacks are particularly relevant to emerging wireless networked systems due to their inherent broadcast nature, spectrum access requirements, and geolocation database requisites [2]. Wireless spectrum access, despite its merits, also brings profound privacy concerns for its users. More specifically, the continuous reporting of spectrum and location data to geo-location database servers raises numerous privacy concerns [3]. Finally, the emergence of quantum computers poses a risk to the long-term security and preservation of privacy in these next-generation networks, challenging existing classical security countermeasures [4]. Efforts are underway to address security issues, including counter-DoS, privacy, and PQ threats in SAS. However, existing solutions work in isolation and do not tackle these issues simultaneously.

The growth of mobile and IoT devices has led to a shortage of spectrum resources. Cognitive Radio Networks (CRN) provide secondary users (SUs) the ability to access unoccupied licensed channels, presenting a prospective solution for spectrum management. While spectrum management serves as a critical wireless resource allocation tool, it faces several security threats, including DoS attacks, due to its broadcast nature, database-driven architecture, and the potential malicious behavior of SUs [5], [6]. Adversaries may target system availability through DoS, aiming to exhaust server resources that handle servicing requests. Previous studies aim to mitigate DoS attacks through intrusion detection systems (IDSs) and mechanisms encompassing network-based solutions, cryptographic techniques, and game theory-based approaches.

Recent progress in machine learning has propelled AI-based IDSs into the spotlight, demonstrating the ability to identify abnormal behavior, with success rates surpassing 95% in some cases [2]. However, despite their merits, these methods may require knowledge and access to broad (in some cases private) network topologies, user-sensitive network traffic, and continuous training on large-scale data [7], [8]. Moreover, they may be vulnerable to AI-based loopholes exploited by attackers with substantial costs to the underlying system [9], [10]. Therefore, it is ideal that they are complemented with counter-DoS techniques that do not rely on such features and can offer additional provable security guarantees.

Client Puzzle Protocols (CPP) permit a client device to access server resources only upon presenting a valid token generated by solving a puzzle like Proof of Work (PoW) [11]. CPPs increase the cost of the DoS attack (e.g., computational, memory) depending on the type of puzzles (e.g., timing, AI-based), thereby mitigating their impact. CPPs can provide an ideal complement to AI-based counter-DoS, but they must possess various properties, such as cost asymmetry, efficiency, statelessness, memorylessness, unforgeability, and non-parallelizability [12]. Given their requisite features and the need for scalability for IoT networks, alleviating the burden of puzzle management from the users and servers is crucial. One such effort is outsourcing puzzle generation and distribution to a trusted entity called “Bastions” [13]. However, these approaches presume the existence of Bastions in applications, presenting just abstract concepts without clarity on which entity assumes the Bastion role, thus missing proper architectural incentives. To benefit from outsourced CCPs, bastions' trust level and architectural duty should be well-justified and integrated into the target application.

The Federal Communications Commission (FCC) has instructed the utilization of centralized SAS, comprising multiple geolocation spectrum databases, to foster dynamic spectrum resource access [14]. This facilitates spectrum sharing between governmental entities and commercial operators, with primary and secondary users. FCC mandates that users provide sensitive information, including precise location coordinates (longitude and latitude), desired spectrum channel, usage data, and transmission details, to access spectrum availability [3]. This not only raises privacy concerns regarding users' confidential data and identity, but also facilitates the tracing and potential exposure of location privacy (e.g., revealing behavioral patterns, lifestyle choices, etc.) [15]. Moreover, the absence of authentication during private spectrum data access, coupled with the reliance on many counter-DoS solutions for authentication, underscores the critical need to prioritize user anonymity and privacy. This gap in spectrum management services necessitates solutions that simultaneously address anonymity, location privacy, and DoS mitigation.

The emergence of quantum computers presents a security risk to NextGen networks, compromising foundational security protocols (e.g., TLS) and undermining critical aspects of SAS, such as DoS protection and privacy safeguards (e.g., [1]). Furthermore, state-of-the-art cryptographic methods used in privacy-preserving techniques, anonymity networks, and counter-DoS solutions rely on cryptographic problems vulnerable to quantum computers. Hence, Post-Quantum Cryptography (PQC) becomes imperative to furnish a robust long-term security solution [4].

Additional Discussion. The study developed the exemplary system (also referred to as “PACDoSQ”) to address the privacy and security challenges stemming from SAS under DoS and quantum computer attacks, as discussed above. The study developed the exemplary system, serving as a counter-DoS system, based on the CPP architecture, which features quantum-safe puzzles where puzzle generation and distribution are delegated to database-driven entities, termed “Private Spectrum Bastions” (PSBs). Integrating bastion services within SAS geo-location databases (DBs) offers several advantages, as PSBs can provide quantum-safe puzzles alongside spectrum availability, thereby maintaining architectural feasibility and enhancing efficiency. The PSB can also pave the way for addressing the location privacy issues associated with spectrum management and outsourced puzzle services.

The database-driven SAS architecture, as mandated by FFC, raises several privacy concerns. Therefore, despite the integration of outsourced CCPs with existing SAS architectures to mitigate DoS attacks, the exemplary system still requires clients to obtain puzzles and spectrum data from PSBs. The study addressed the privacy concerns as follows. (i) The study harnessed distributed Private Information Retrieval (PIR) protocols [16] that synergize with multi-server PSB architecture [1]. The client device fetches spectrum information and CCPs privately, in accordance with FFC regulations. Moreover, the choice of PIR protocol permits resiliency against network failures and some subsets of non-responding PSB servers. (ii) The study ensured the client device connects to PSBs and performs private retrieval operations through a post-quantum secure version of the Tor network [17], thereby providing anonymous access.

The exemplary system provides all the above desirable security and privacy features with a post-quantum guarantee thanks to the reliance on NIST-PQC standards in Tor and information-theoretically secure PIR operations.

### Conclusion

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] M. Grissa, A. A. Yavuz, B. Hamdaoui, and C. Tirupathi, “Anonymous dynamic spectrum access and sharing mechanisms for the cbrs band,” IEEE Access, vol. 9, pp. 33860-33879, 2021.
[2] T. Chakraborty, S. Mitra, and S. Mittal, “Capow: Context-aware aiassisted proof of work based ddos defense,” arXiv preprint, 2023.
[3] D. K. Jasim and S. B. Sadkhan, “Cognitive radio network: Security and reliability trade-off-status, challenges, and future trend,” in 2021 1st BICITS, pp. 149-153, IEEE, 2021.
[4] S. Darzi, K. Ahmadi, and S. Aghapour, “Envisioning the future of cyber security in post-quantum era: A survey on pq standardization, applications, challenges and opportunities,” arXiv:2310.12037, 2023.
[5] T. Chakraborty, A. Islam, and V. King, “Bankrupting dos attackers despite uncertainty,” arXiv preprint arXiv:2205.08287, 2022.
[6] M. Grissa, A. Yavuz, and B. Hamdaoui, “Lpos: Location privacy for optimal sensing in cognitive radio networks,” in 2015 IEEE Global Communications Conference (GLOBECOM), pp. 1-6, IEEE, 2015.
[7] S. Darzi and A. A. Yavuz, “Counter denial of service for next-generation networks within the artificial intelligence and post-quantum era,” arXiv preprint arXiv:2408.04725, 2024.
[8] P. H. Masur, J. H. Reed, and N. K. Tripathi, “Artificial intelligence in open-radio access network,” IEEE Aerospace and Electronic Systems Magazine, vol. 37, no. 9, pp. 6-15, 2022.
[9] R. Doriguzzi-Corin and D. Siracusa, “Flad: adaptive federated learning for ddos attack detection,” Computers & Security, vol. 137, 2024.
[10] M. Mittal, K. Kumar, and S. Behal, “Deep learning approaches for detecting ddos attacks: A systematic review,” Soft computing, vol. 27, no. 18, pp. 13039-13075, 2023.
[11] V. Bostanov, “Client puzzle protocols as countermeasure against automated threats to web applications,” IEEE Access, vol. 9, 2021.
[12] I. M. Ali, M. Caprolu, and R. D. Pietro, “Foundations, properties, and security applications of puzzles: A survey,” ACM Computing Surveys (CSUR), vol. 53, no. 4, pp. 1-38, 2020.
[13] F. N. Kiruthika, “A new approach to defend against ddos.,” Computer Science & Telecommunications, vol. 31, no. 2, 2011.
[14] M. Grissa, A. Yavuz, and B. Hamdaoui, “An efficient technique for protecting location privacy of cooperative spectrum sensing users,” in 2016 IEEE conf. on comp. comm. workshops, IEEE, 2016.
[15] P. Agarwal, M. Manekiya, T. Ahmad, A. Yadav, A. Kumar, M. Donelli, and S. T. Mishra, “A survey on citizens broadband radio service (cbrs),” Electronics, vol. 11, no. 23, p. 3985, 2022.
[16] I. Goldberg, “Improving the robustness of private information retrieval,” in 2007 IEEE Symposium on Security and Privacy (SP'07), IEEE, 2007.
[17] Z. Tujner, “Quantum-safe tor, post-quantum cryptography,” Master's thesis, University of Twente, 2019.
[18] J. Bos, L. Ducas, E. Kiltz, and Lepoint, “Crystals-kyber: a cca-secure module-lattice-based kem,” in 2018 IEEE European Symposium on Security and Privacy (EuroS&P), pp. 353-367, IEEE, 2018.
[19] L. Ducas, E. Kiltz, and T. Lepoint, “Crystals-dilithium: A latticebased digital signature scheme,” IACR Transactions on Cryptographic Hardware and Embedded Systems, pp. 238-268, 2018.
[20] T. Aura and P. Nikander, “Dos-resistant authentication with client puzzles,” in Intl. workshop on sec. prtcl., Springer, 2000.
[21] B. Glas and J. Guajardo, “Signal-based automotive communication security and its interplay with safety requirements,” in Proceedings of Embedded Security in Cars Conference, Citeseer, 2012.
[22] X. Bonnetain and Naya-Plasencia, “Quantum security analysis of aes,” IACR Tran. on Sym. Cryp., vol. 2019, no. 2, 2019.
[23] “Tor metrics.” https://metrics.torproject.org/torperf.html, 2024. Accessed: May 2024.

What is claimed:

1. A system comprising:
a processor; and
a memory having instructions stored thereon, wherein execution of the instructions causes the processor to:
generate a privacy-preserving spectrum database configured to provide spectrum availability information in a privacy-preserving request from a user device, the spectrum database comprising a plurality of blocks corresponding to an accessible spectrum and assignable to a computing device, wherein each of the plurality of blocks is indexed by one or more privacy-preserving spectrum management parameters;
generate one or more puzzles, wherein each of the one or more puzzles is (i) stored in a respective index defined and retrievable by one or more privacy-preserving spectrum management parameters and (ii) assigned a signature associated with the respective puzzle and a secret key; and
in response to a received privacy-preserving request from the user device to access a public server having services or data of interest to the computing device, the request comprising a plurality of privacy-preserving spectrum management parameters, retrieve a puzzle referenced in an index of the database using the plurality of privacy-preserving spectrum management parameters;
transmit, via a quantum cryptography compliant and secure server connected to the system, the retrieved puzzle and associated signature to the user device in a privacy-preserving response, wherein the transmitted puzzle is used by the user device to perform a computation task to determine a token, and wherein the token and signature are transmitted to the public server in a request for access to the public server.

2. The system of claim 1, wherein each of the one or more puzzles is a quantum-safe puzzle based on a cryptographic hash function.

3. The system of claim 1, wherein the puzzle is pre-computed and pre-stored.

4. The system of claim 1, wherein each of the associated signatures is a Dilithium signature.

5. The system of claim 1, wherein the privacy-preserving request is received from a computing device via a Private Information Retrieval (PIR) protocol.

6. The system of claim 1, wherein the puzzle is generated via a puzzle generation function that has function inputs associated with a difficulty level and a security level, and wherein the difficulty level and/or security level is specified for different types of devices.

7. The system of claim 2, wherein the token is determined using an identification (ID) of the public server and a hash value derived from the received puzzle.

8. The system of claim 7, wherein execution of the instructions causes the processor to:
subsequent to the user device receiving the privacy-preserving response, check for data defects in the retrieved puzzle and/or associated signature; and
in response to defects being detected in the retrieved puzzle and/or associated signature, reconstruct the privacy-preserving response using an error-correction algorithm.

9. A public server accessible to a user device, the public server comprising:
a processor; and
a memory having instructions stored thereon, wherein execution of the instructions causes the processor to:
receive, from the user device seeking access to the server, an access request comprising a puzzle, a token, and a signature, wherein the received token was calculated from the puzzle retrieved by the user device from a privacy-preserving database, the user device retrieved the puzzle via an index determined from privacy-preserving spectrum management parameters that mask or obfuscate the user device identify or associated identify information;
compute, via a signature verification operation, the validity of the received signature using a public key and the received signature;
compute, via a token verification operation, the validity of the received token using the retrieved puzzle and the received token; and
in response to the signature of the received puzzle and the received token being valid, grant access to the user device.

10. The public server of claim 9, wherein the puzzle is a quantum-safe puzzle.

11. The public server of claim 9, wherein the puzzle is pre-computed and pre-stored in a PSB.

12. The public server of claim 9, wherein the signature is a Dilithium signature.

13. The public server of claim 9, wherein the received puzzle is generated via a puzzle generation function that has function inputs associated with a difficulty level and a security level, and wherein the difficulty level and/or security level is specified for different types of devices.

14. A non-transitory computer-readable medium for a user device, the medium comprising:
instructions to (i) send a privacy-preserving request to a privacy-preserving spectrum database of a private spectrum bastion (PSB) to access a public server having services or data of interest to the user device, the user device having one or more privacy-preserving spectrum management parameters, and (ii) receive a puzzle referenced in an index of the database using the one or more privacy-preserving spectrum management parameters;
instructions to determine a token using an identification (ID) of a public server accessible to the user device and a hash value derived from the received puzzle;
instructions to transmit, via a quantum cryptography compliant and secure server connected to the PSB, the received puzzle and associated signature, to the public server in a request for access to the public server.

15. The non-transitory computer-readable medium of claim 14 further comprising:
subsequent to receiving the puzzle in a privacy-preserving response from the PSB, instructions to check for data defects in the received puzzle and/or the associated signature; and
in response to defects being detected in the received puzzle and/or the associated signature, instructions to reconstruct the privacy-preserving response using an error-correction algorithm.

16. The non-transitory computer-readable medium of claim 14, wherein the received puzzle is a quantum-safe puzzle.

17. The non-transitory computer-readable medium of claim 14, wherein the received puzzle is pre-computed and pre-stored.

18. The non-transitory computer-readable medium of claim 14, wherein the associated signature is a Dilithium signature.

19. The non-transitory computer-readable medium of claim 14, wherein the privacy-preserving request is received at the PSB from the user device via a Private Information Retrieval (PIR) protocol.

20. The non-transitory computer-readable medium of claim 14, wherein the received puzzle is generated via a puzzle generation function that has function inputs associated with a difficulty level and a security level, and wherein the difficulty level and/or security level is specified for different types of devices.
